(19) United States
(12) Patent Application Publication
(10) Pub. No.: US 2015/0143988 A1
(43) Pub. Date: May 28, 2015

(54) Pneumatic Actuation Devices For Valves and the Like

(71) Applicants: Jahangir S Rastegar, Stony Brook, NY (US); Jacques Fischer, Sound Beach, NY (US)

(72) Inventors: Jahangir S Rastegar, Stony Brook, NY (US); Jacques Fischer, Sound Beach, NY (US)

(73) Assignee: OMNITEK PARTNERS LLC, Ronkonkoma, NY (US)

(21) Appl. No.: 14/552,443

(22) Filed: Nov. 24, 2014

Related U.S. Application Data
(60) Provisional application No. 61/909,371, filed on Nov. 26, 2013.

(51) Int. Cl. F15B 15/02; F15B 15/20

(52) U.S. Cl. CPC F15B 15/02; F15B 15/20
USPC 91/508; 91/471

(57) ABSTRACT

A stepper motor including: a plurality of actuators, each having an actuation rod movable between retracted and expended positions, the actuation rod having an actuation pin movable along with the actuation rod; and a shuttle rotatable about a shaft, the shuttle having a plurality of pockets corresponding to the actuation pin of the plurality of actuators, the plurality of pockets being partially offset from the plurality of pins such that actuation of one or more of the plurality of actuators moves the actuation rod and corresponding actuation pin into a corresponding one of the plurality of pockets to rotate the shuttle about the shaft.

### CROSS-REFERENCE TO RELATED APPLICATIONS

This application claims the benefit of U.S. Provisional Application No. 61/909,371 filed on Nov. 26, 2014, the entire contents of which is incorporated herein by reference.

This application is related to U.S. Pat. Nos. 8,110,785; 8,513,582 and 8,193,754 and U.S. Patent Application Publication No. 2013/0074623, the contents of each of which are incorporated herein by reference.

### BACKGROUND OF THE INVENTION

1. Field of the Invention

The present invention relates generally to actuators, and more particularly to mechanical stepper motor like actuators for actuating valves and the like. The actuators are particularly suitable for control of valve opening in a feedback controlled system in industrial processes and the like.

2. Prior Art

In many large valve applications, the actuation devices are preferably pneumatic for safety and in many applications due to fire hazard. Most currently available valve pneumatic actuation devices provide only two positions control for the valve and work with one pneumatic piston 102 (FIG. 1) or a pair of pistons 104 (FIGS. 2 and 3) that work together to provide the actuation torque with minimal lateral loading of the valve shaft being actuated. The latter actuation devices are particularly advantageous for larger valves that require large actuating torques. In general, the linear motion of the pneumatic piston is converted to rotary motion through a mechanism such as a rack and gear 106 (FIGS. 1-2) or a scotch yoke 108 (FIG. 3) or the like to an output shaft 109. In such actuation devices such as those shown in FIGS. 1-3, when the pneumatic piston is pressurized through port 108, the valve shaft 109 is actuated to one position (e.g., fully or partially open or closed) and when the air pressure is relieved through port 110, preloaded springs 112 are used to return the valve shaft 109 to another (second) position.

Currently there are also actuation devices for valves that are pneumatic and are used for positioning the valve using a feedback loop to a desired position. However, since these valve actuation devices attempt to position the valve by providing differential air or other gas pressures to either both sides of a rotationally actuating piston “piston” or to two pneumatic pistons with opposing linear actuating motions (similar to those of FIGS. 2 and 3), and since air even when pressurized acts as a very soft spring, therefore such pneumatic actuation devices cannot provide the means of accurately positioning valves at the desired position in a feedback control system. This is particularly the case when the flow through the valve being controlled generates a significant load and/or when the load could vary relatively fast.

### SUMMARY OF THE INVENTION

The disclosed embodiments address the above shortcomings of the currently available pneumatic actuation devices for valves and other similar devices. The disclosed embodiments use a modification of mechanical stepper motor type actuation devices described in U.S. Pat. No. 8,193,754 through a series of novel mechanisms to provide actuation devices that are suitable for full pneumatic control (in a feedback or an open-loop mode) of various valves. In fact, the disclosed novel embodiments are shown to provide the advantages of electrically powered and electric motor driven actuation devices for valves in a significantly smaller volume and with the very basic and important advantage of being pneumatic.

Accordingly, a stepper motor is provided. The stepper motor comprising: a plurality of actuators, each having an actuation rod movable between retracted and expended positions, the actuation rod having an actuation pin movable along with the actuation rod; and a shuttle rotatable about a shaft, the shuttle having a plurality of pockets corresponding to the actuation pin of the plurality of actuators, the plurality of pockets being partially offset from the plurality of pins such that actuation of one or more of the plurality of actuators moves the actuation rod and corresponding actuation pin into a corresponding one of the plurality of pockets to rotate the shuttle about the shaft.

The plurality of actuators can be arranged radially about the shaft. The shuttle can be a disc shaped wheel wherein the plurality of pockets are radially aligned with the plurality of actuators.

The plurality of actuators can be arranged longitudinally with the shaft.

The plurality of actuators can be provided in an even number and can be actuated in opposing pairs.

The plurality of actuators can be pneumatic actuators.

The shaft can include a mating device for connection to another device. The mating device can be a spline.

The stepper motor can further comprise one or more return position actuators having an output shaft connected to the valve shaft such that actuation of the one or more return position actuators inputs a rotation torque to the shaft.

Also provided is a method for rotating a shaft in discrete rotational steps. The method comprising: moving a plurality of actuation rods between retracted and expended positions, the actuation rods each having an actuation pin movable along with the actuation rod; and engaging one or more of the pins with a corresponding pocket on a shuttle rotatable about a shaft, the plurality of pockets being partially offset from the plurality of pins such that actuation of one or more of the plurality of actuation rods moves the actuation rod and corresponding actuation pin into a corresponding one of the plurality of pockets to rotate the shuttle about the shaft in the discrete step.

### BRIEF DESCRIPTION OF THE DRAWINGS

These and other features, aspects, and advantages of the apparatus of the present invention will become better understood with regard to the following description, appended claims, and accompanying drawings where:

FIG. 1 illustrates a cut-away view of a single piston pneumatic valve of the prior art.

FIG. 2 illustrates a cut-away view of a double piston pneumatic valve of the prior art.

FIG. 3 illustrates a cut-away view of another type of double piston pneumatic valve of the prior art.

FIG. 4 illustrates a partial cut-away view of a first embodiment of pneumatic valve.

FIG. 5 illustrates the valve of FIG. 4 shown without a cover to expose six operating cylinders and actuator wheel.

FIG. 6 illustrates the valve of FIG. 5 showing the operating cylinders in relation to the actuator wheel.

FIGS. 7a-7c illustrate the valve of FIG. 4 showing a sequential actuation of pairs of piston tip rollers to rotate the actuator wheel.

FIGS. 8 and 9 illustrate isometric views of the actuation device as viewed from the bottom and top, respectively.

FIG. 10 illustrates a plan view of the actuation device of FIG. 4 from the top.

FIG. 11 illustrates a side cross-sectional view of the valve of FIG. 4.

FIG. 12 illustrates a second embodiment of a pneumatic valve having the actuators top mounted.

### DETAILED DESCRIPTION OF THE PREFERRED EMBODIMENT

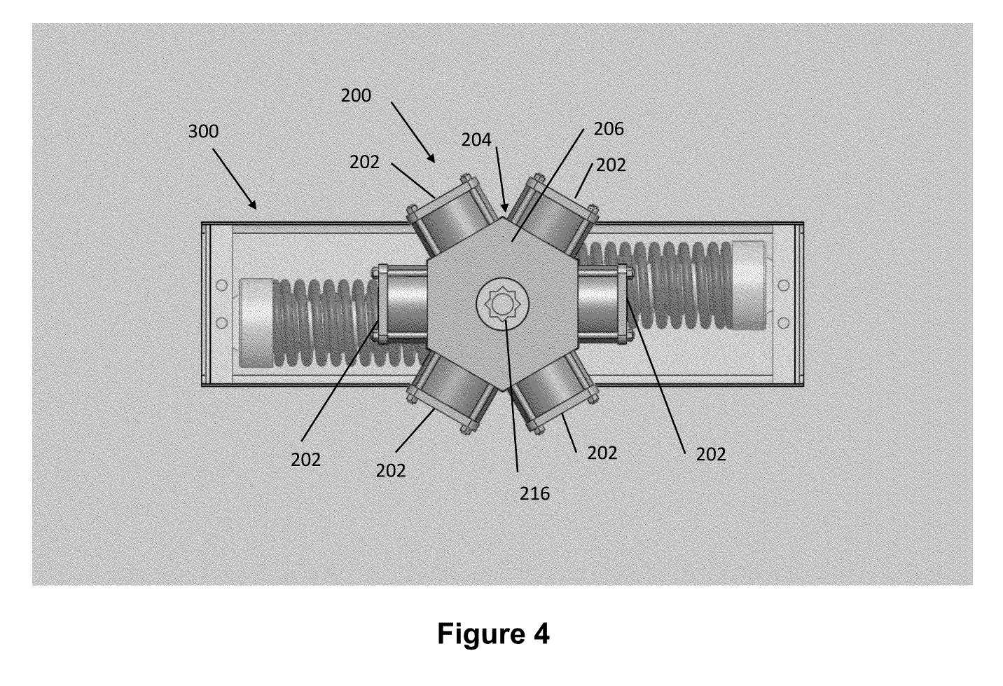

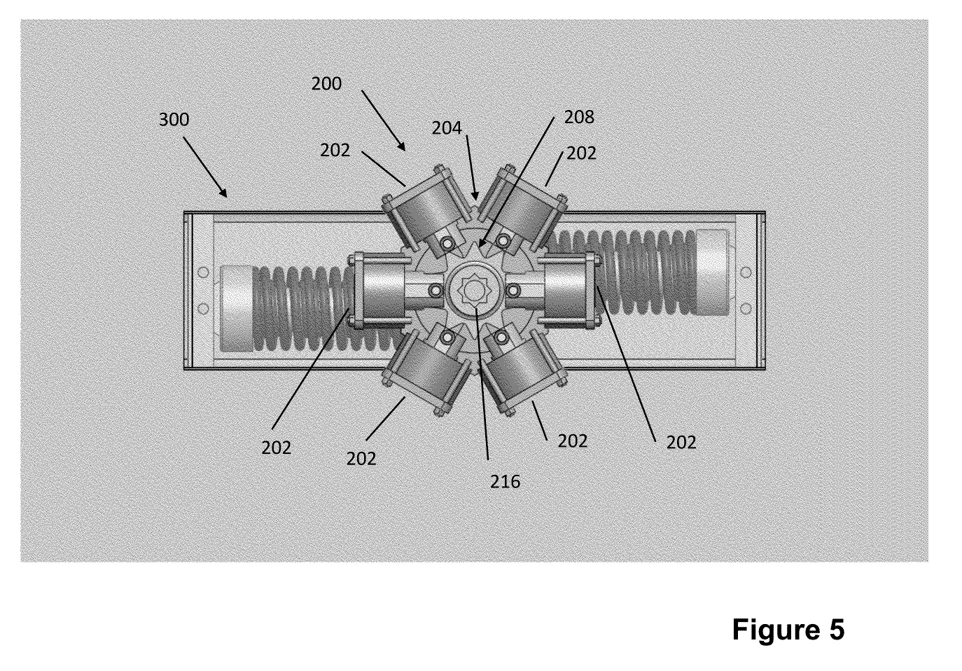

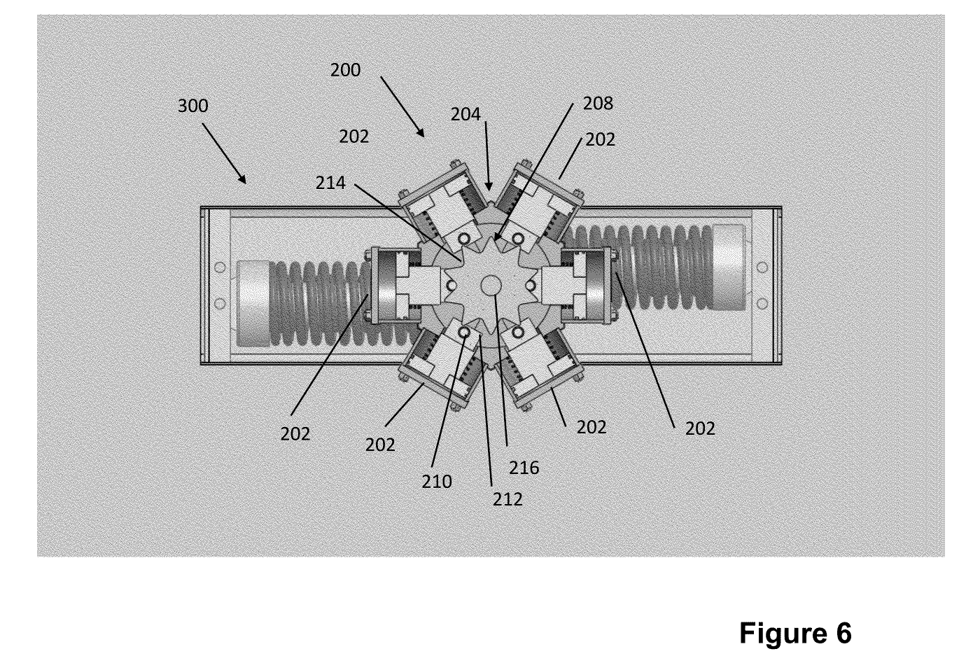

Referring first to FIG. 4-6, there is shown a first embodiment of a stepper motor 200. The stepper motor 200 is shown with optional return position pneumatic cylinders 300, described below. This stepper motor of FIGS. 4-6 is designed to provide even for full rotation of the valve if desired, even though in most valves no more than slightly larger than 180 degrees rotation is required. FIG. 4 shows the stepper motor 200 with six individual pneumatic stepper actuators 202 and stepper housing 204. FIG. 5 shows the stepper motor 200 with a housing cover 206 removed so as to expose a shuttle wheel 208. FIG. 6 shows the stepper motor of FIG. 5 sectioned so as to further expose an interior of the individual pneumatic stepper actuators 202 and the interaction of actuating pins 210 connected to an actuating rod 212 for each of the individual pneumatic stepper actuators 202 with a corresponding pocket 214 on the shuttle wheel 208.

As discussed in U.S. Pat. No. 8,193,754 the operation of the stepper motor 200 is based on the principles of operation of simple Verniers. A Vernier (also called a Vernier scale) is “A small, movable auxiliary graduated scale attached parallel to a main graduated scale, calibrated to indicate fractional parts of the subdivisions of the larger scale, and used on certain precision instruments to increase accuracy in measurement” (The Free Dictionary by Farlex, Inc., 1051 County Line Road Suite 100, Huntingdon Valley, Pa. 19006).

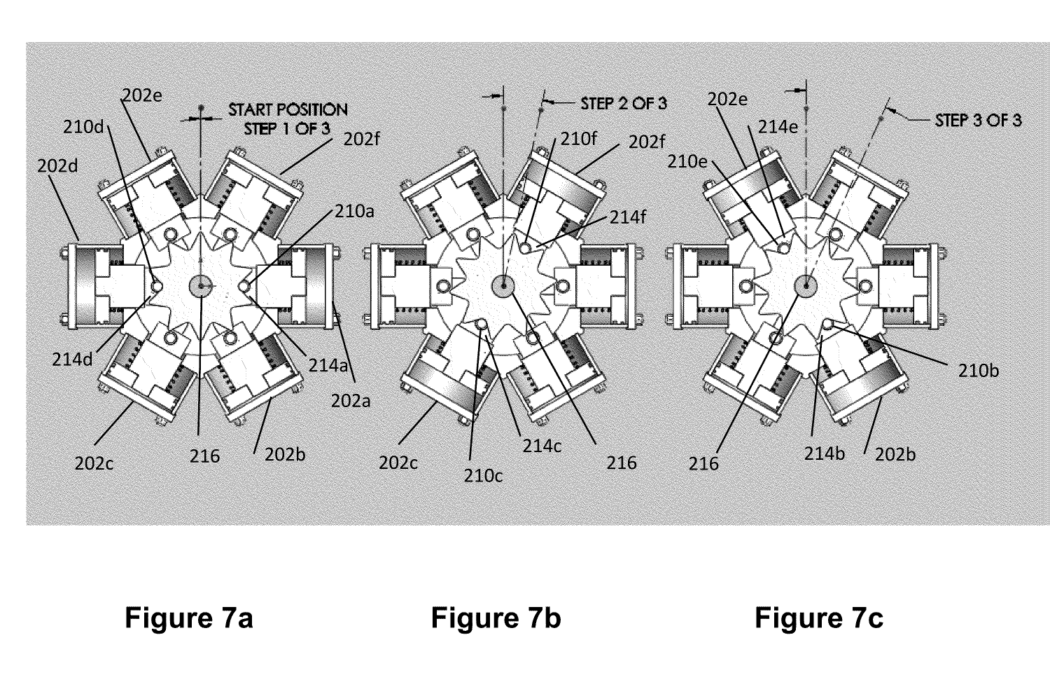

Referring now to FIGS. 7a-7c, the same illustrate how sequential actuation of opposing pairs of the individual pneumatic stepper actuators 202 can rotate the shuttle wheel, which is directly attached to a valve shaft 216 to affect its rotation in either clockwise or counterclockwise directions. In the stepper motor 200, the individual pneumatic stepper actuators 202 are actuated in pairs (with pressurization as is known in the art) such that the actuating rods 212 extend and the actuating pins 210 thereon interact with the pockets 214 of the shuttle wheel 208.

In FIGS. 7a-7c, the individual pneumatic actuators, pins and pockets have been designated with the reference numeral used above and further individually identified with letters a-f so as to simply the below description. FIG. 7a shows actuators 202a and 202d being actuated corresponding to a start position (step 1) where the corresponding actuator pins 210a and 210d are disposed in corresponding pockets 214a and 214d in the shuttle wheel 208. FIG. 7b shows withdrawal of pins 210a and 210d (by venting actuators 202a and 202d allowing bias spring 218 to withdraw the pins 210a and 210d from engaging the pockets 214a and 214d). Simultaneously, concurrently or subsequently, actuators 202c and 202f are actuated (by being pressurized as is known in the art) resulting in a rotation of the shuttle wheel 208 and valve shaft 216 connected thereto (step 2) as shown in FIG. 7b. Similarly, in FIG. 7c, actuators 202c and 202f are withdrawn (vented) and actuators 202b and 202e are actuated (by being pressurized as is known in the art) resulting in a rotation of the shuttle wheel 208 and valve shaft 216 connected thereto (step 3) as shown in FIG. 7b. The number of actuators 202 and corresponding pockets 214 determine the size of the steps, the more steps the smaller the size of the step. The process can continue until the desired step size occurs. As can be seen from FIGS. 7a-7c, rotation can be stepwise or continuous and can also be clockwise or counterclockwise.

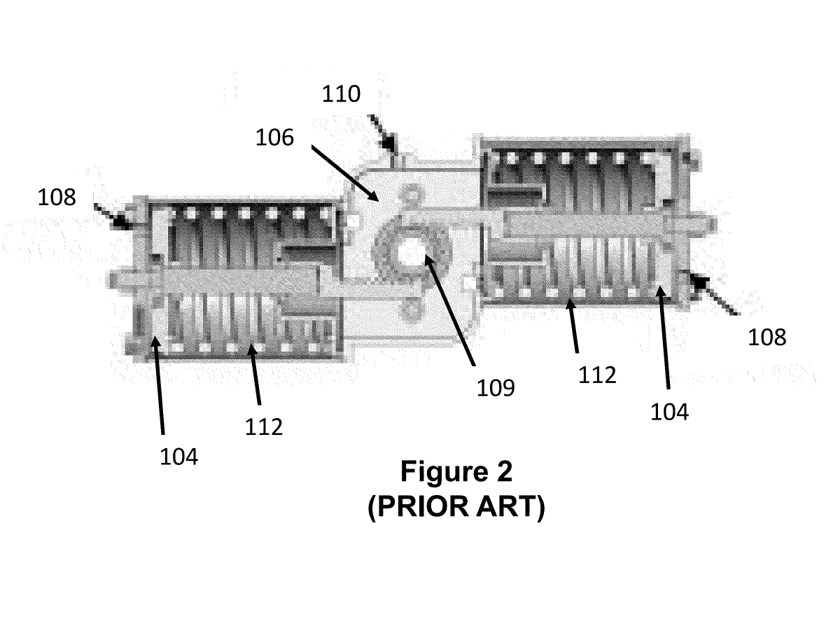

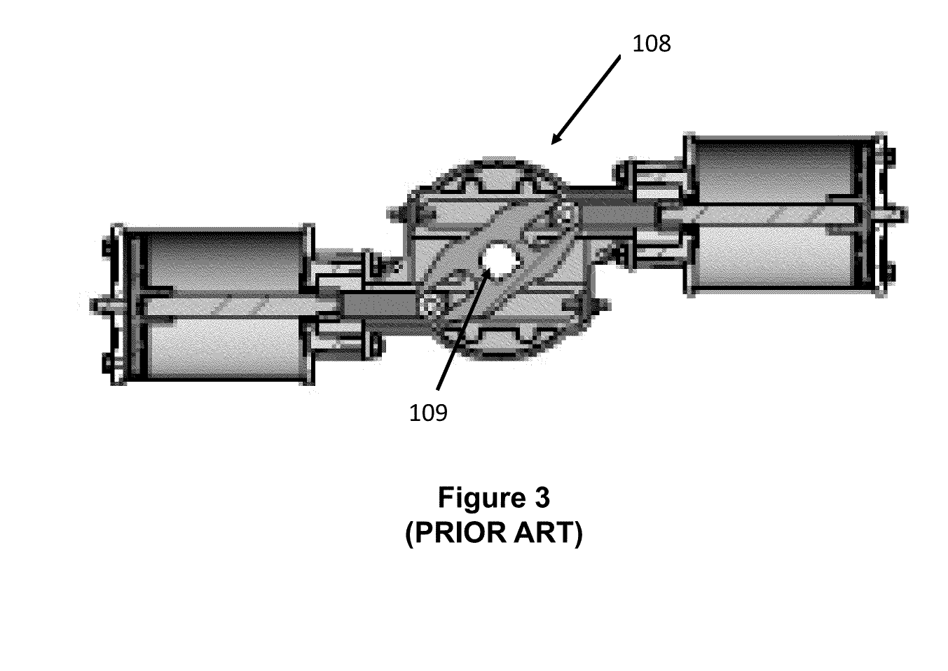

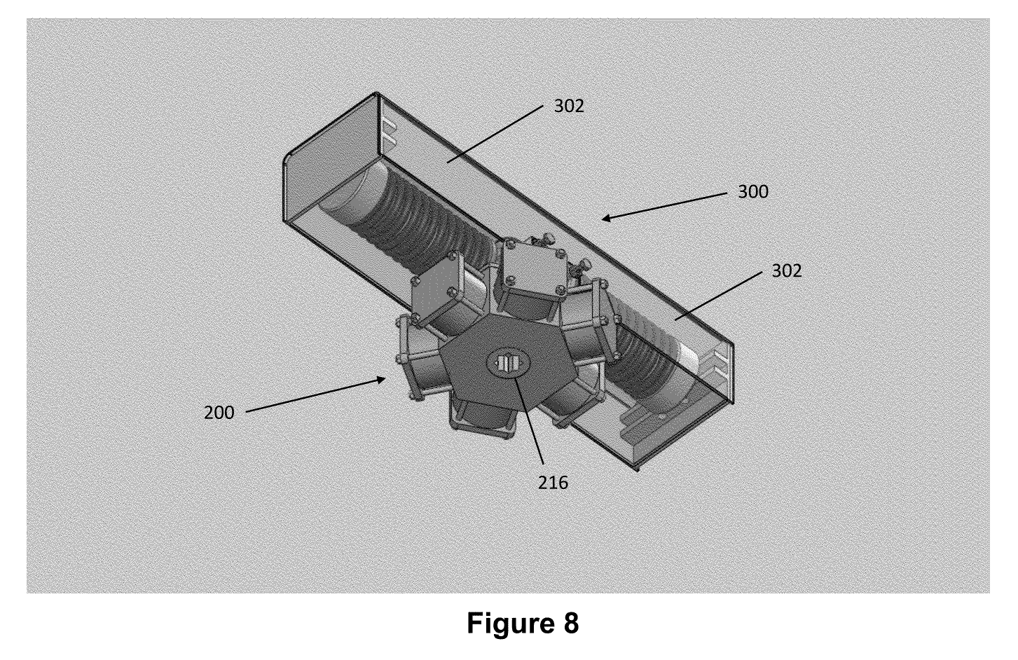

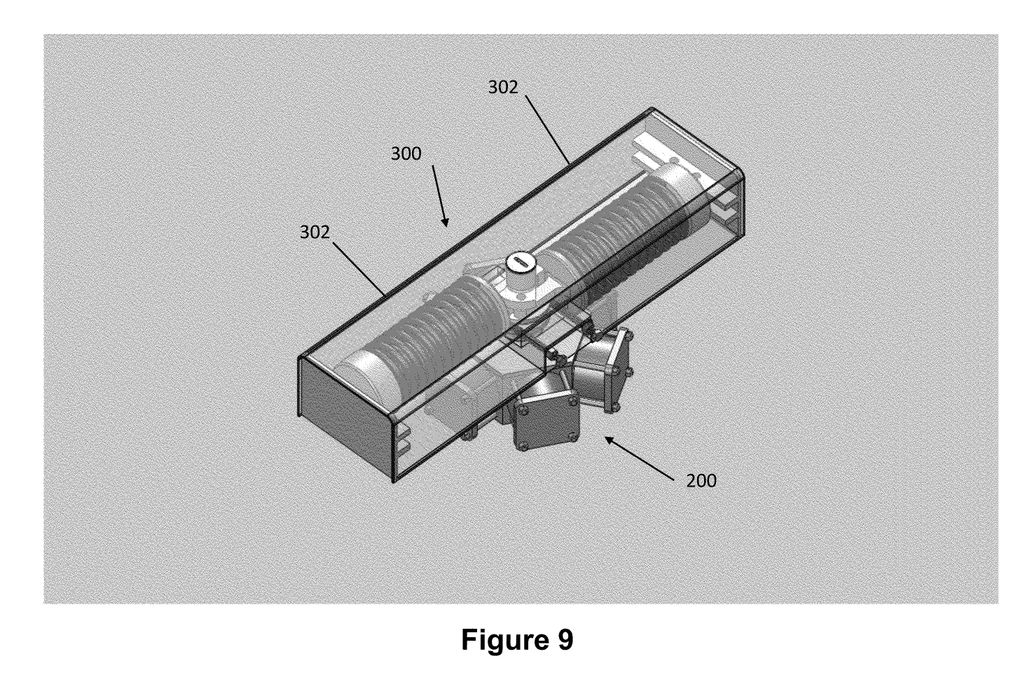

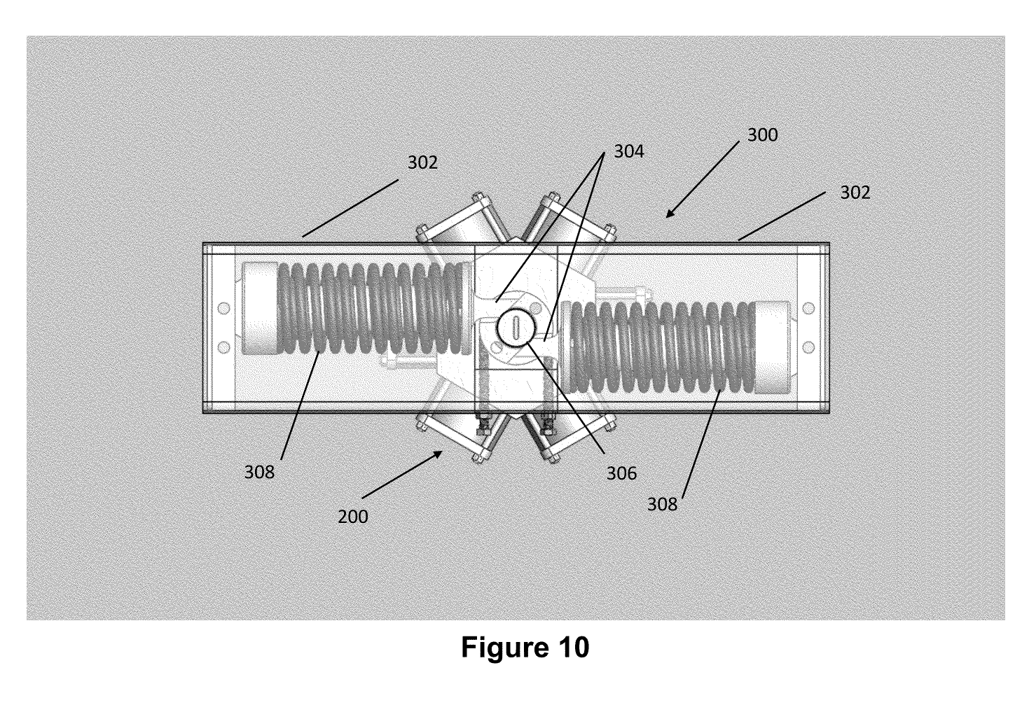

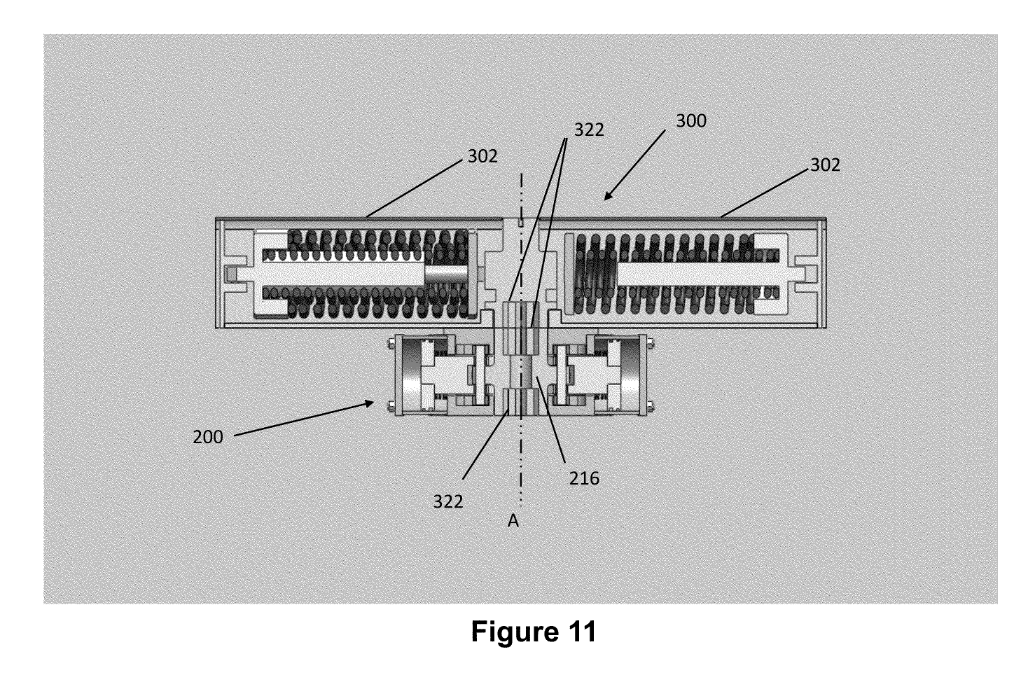

Referring now to FIGS. 8-11, there is described the optional return position pneumatic cylinders 300. FIGS. 8 and 9 are top and bottom isometric views, respectively, of the actuation device. FIG. 10 is the view of the actuation device from the top. FIG. 11 is the side cross-sectional view of the device. The return position pneumatic cylinders 300 are configured similarly to those described above with regard to FIGS. 2 and 3. That is, the return position pneumatic cylinders 300 comprise opposing actuators 302, which when pressurized, extend a rod 304 to rotate a secondary shaft 306 against a biasing force of a return spring 308. As shown in FIG. 11, the secondary shaft 306 is connected to the valve shaft 216, such as with splines 320 so as to rotate together along a common axis A. The valve shaft 216 can also include a spline 322 or other mating device so as to mate with an input shaft of another device to be actuated. When actuated, the return position pneumatic cylinders 300 output a rotation torque which can stabilize the position of the valve shaft 216 during one of the configurations shown in FIGS. 7a-7c or can return the valve shaft 216 to a neutral (or other predetermined) position when none of the individual pneumatic stepper actuators 202 are actuated (none of the pins 210 are engaged with corresponding pockets 214.

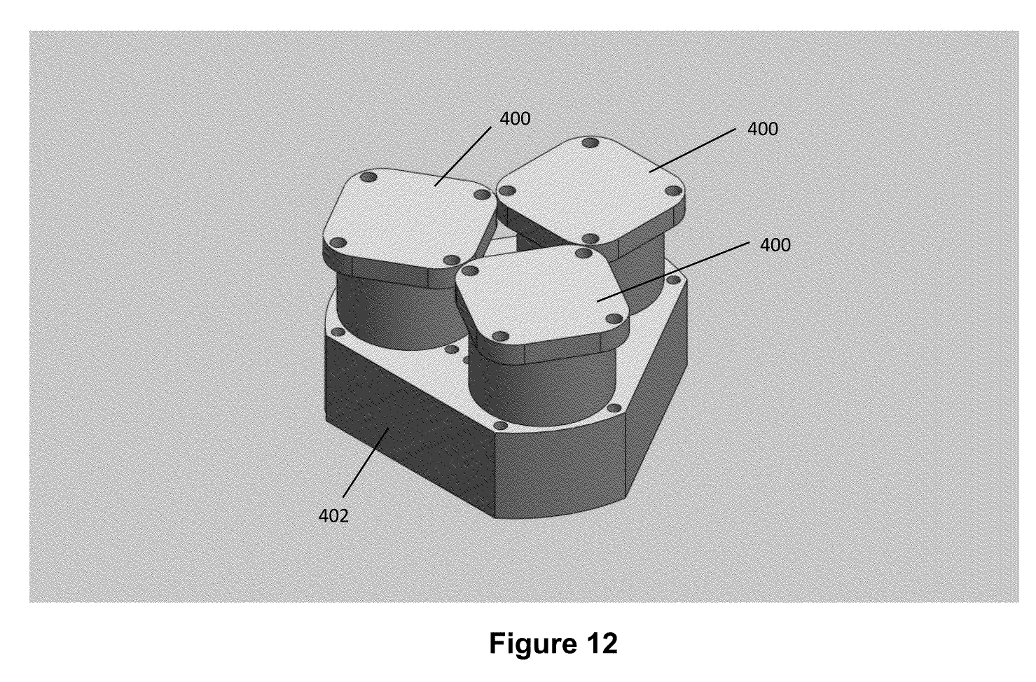

FIG. 12 illustrates the same actuation device, with the difference that instead of using pairs of actuators mounted so as to actuate axially (perpendicular to the output shaft) the actuators 400 can be positioned about a base plate 402 so as to actuate longitudinally (parallel with the output shaft) similarly to that described in U.S. Pat. No. 8,193,754 with the actuator wheel (not shown) being cylindrical and having pockets formed on an edge thereof along a partial arc.

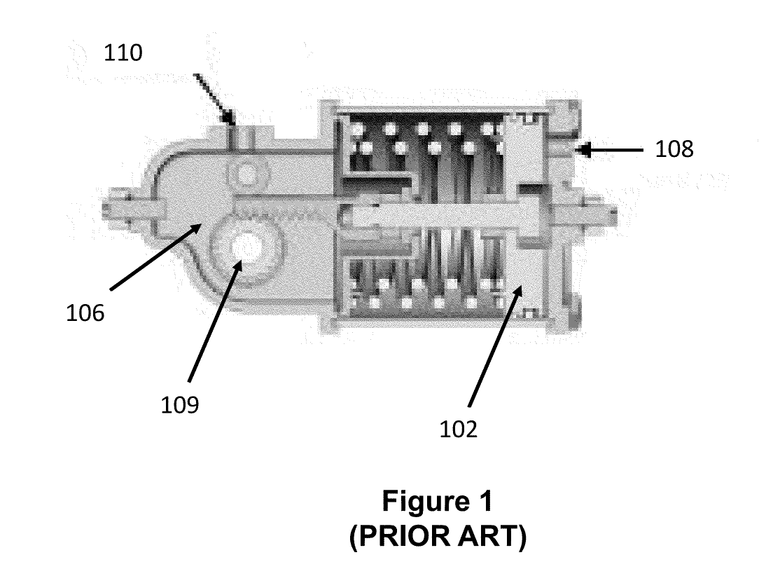

It will also be appreciated by those skilled in the art that the stepper motors of FIGS. 4-11 may also be similarly driven with more or less actuators, such as three single actuating pistons that are actuated individually (not in pairs). In addition, one may also use the same “stepper motor” actuation to drive the rack of the actuation devices shown in FIGS. 1 and 2.

It will also be appreciated by those skilled in the art that using the stepper motors described above, numerous other configurations may also be designed and the present disclosure is not intended to exclude such other design configurations for actuating valves or other similar devices.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A stepper motor comprising:
a plurality of actuators, each having an actuation rod movable between retracted and expended positions, the actuation rod having an actuation pin movable along with the actuation rod; and
a shuttle rotatable about a shaft, the shuttle having a plurality of pockets corresponding to the actuation pin of the plurality of actuators, the plurality of pockets being partially offset from the plurality of pins such that actuation of one or more of the plurality of actuators moves the actuation rod and corresponding actuation pin into a corresponding one of the plurality of pockets to rotate the shuttle about the shaft.

2. The stepper motor of claim 1, wherein the plurality of actuators are arranged radially about the shaft.

3. The stepper motor of claim 2, wherein the shuttle is a disc shaped wheel wherein the plurality of pockets are radially aligned with the plurality of actuators.

4. The stepper motor of claim 1, wherein the plurality of actuators are arranged longitudinally with the shaft.

5. The stepper motor of claim 1, wherein the plurality of actuators are provided in an even number and are actuated in opposing pairs.

6. The stepper motor of claim 1, wherein the plurality of actuators are pneumatic actuators.

7. The stepper motor of claim 1, wherein the shaft includes a mating device for connection to another device.

8. The stepper motor of claim 7, wherein the mating device is a spline.

9. The stepper motor of claim 1, further comprising one or more return position actuators having an output shaft connected to the valve shaft such that actuation of the one or more return position actuators inputs a rotation torque to the shaft.

10. A method for rotating a shaft in discrete rotational steps, the method comprising:
moving a plurality of actuation rods between retracted and expended positions, the actuation rods each having an actuation pin movable along with the actuation rod; and
engaging one or more of the pins with a corresponding pocket on a shuttle rotatable about a shaft, the plurality of pockets being partially offset from the plurality of pins such that actuation of one or more of the plurality of actuation rods moves the actuation rod and corresponding actuation pin into a corresponding one of the plurality of pockets to rotate the shuttle about the shaft in the discrete step.
